(19) United States
(12) Patent Application Publication
(10) Pub. No.: US 2026/0214353 A1
(43) Pub. Date: Jul. 23, 2026

(54) IMAGE SENSOR AND CAMERA ASSEMBLY

(71) Applicant: Rayprus Technology (Foshan) Co., Ltd., Foshan (CN)

(72) Inventors: CHAO-YU QIN, Shenzhen (CN); LONG-FEI ZHANG, Shenzhen (CN); ZHI-WEI LI, Jincheng (CN)

(21) Appl. No.: 19/571,857

(22) Filed: Mar. 19, 2026

(30) Foreign Application Priority Data
Apr. 17, 2025 (CN) 202510486695.7

(51) Int. Cl. H04N 25/702; H04N 23/55

(52) U.S. Cl. CPC H04N 25/702; H04N 23/55

(57) ABSTRACT

An image sensor applied to a camera assembly including a lens assembly, the image sensor includes: a substrate including a curved photosensitive surface facing the lens assembly and arranged at a focus of ambient light transmitted from the lens assembly; and a plurality of pixels on the photosensitive surface and arranged in an array including a plurality of rows and a plurality of columns, and each of the plurality of row extending along a first direction X and each of the plurality of columns extending along a second direction Y perpendicular to the first direction X. A spacing between geometric centers of each two adjacent pixels of the plurality of pixels gradually decreases from a center to an edge of the substrate. A camera assembly is also provided.

### FIELD

The subject matter herein relates to an image sensor and a camera assembly including the image sensor.

### BACKGROUND

Conventional wide-angle cameras frequently exhibit optical distortion, causing peripheral image deformation. Standard correction involves extrinsic parameter calibration followed by algorithmic de-warping, but this leads to inefficient sensor pixel utilization of an image sensor and persistent post-processing blurring at the edges of images.

### BRIEF DESCRIPTION OF THE DRAWINGS

Implementations of the present disclosure will now be described, by way of embodiment, with reference to the attached figures, wherein:

FIG. 1 shows an image sensor and a camera assembly according to an embodiment of the present disclosure.

FIG. 2 shows an image sensor and a camera assembly according to another embodiment of the present disclosure.

FIG. 3 shows pixels of the image sensor according to an embodiment of the present disclosure.

FIG. 4 shows pixels of the image sensor according to another embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “comprising,” when utilized, means “including, but not necessarily limited to”; it specifically indicates open-ended inclusion or membership in the so-described combination, group, series, and the like.

When a feature or element is herein referred to as being “on” another feature or element, it can be directly on the other feature or element or intervening features and/or elements may also be present. It will also be understood that, when a feature or element is referred to as being “connected”, to another feature or element, it can be directly connected, attached, or coupled to the other feature or element or an intervening features or elements may be present.

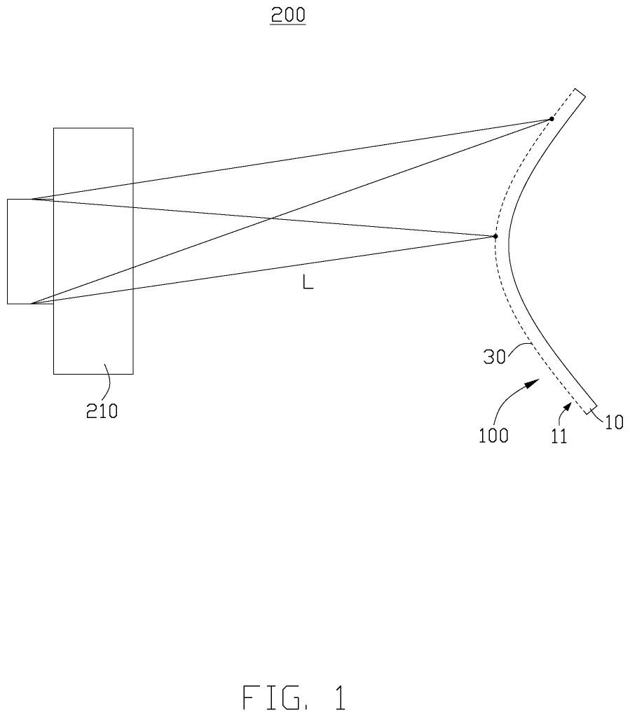

Referring to FIG. 1, an image sensor 100 in this embodiment of the present disclosure includes a substrate 10 and a plurality of pixels 30 on a photosensitive surface 11 of the substrate 10, wherein each pixel 30 includes at least one photodetector.

A camera assembly 200 in this embodiment includes the image sensor 100 and a lens assembly 210. The lens assembly 210 is used to focus ambient light L on the photosensitive surface 11 of the image sensor 100, and the pixels 30 on the photosensitive surface 11 is used to transfer the ambient light L received into electrical signals, that is image signals, thus achieving an image capture function.

The photosensitive surface 11 is curved to focus the ambient L from the lens assembly 210 onto the photosensitive surface 11. Due to an optical performance of a lens assembly, on-axis and off-axis lights may exhibit different focal lengths. That is, light transmitted from a central region of the lens assembly converges at a nearer focal point, while light transmitted from a peripheral (edge) region of the lens assembly converges at a farther focal point, which results in the light transmitted from the edge region being unable to focus onto the same flat photosensitive surface as the light transmitted from the central region. Therefore, the curved photosensitive surface 11 of this embodiment can be compatible with the lens assembly 210, ensuring the ambient light L emitted from different directions of the lens assembly 210 can all be converged onto the photosensitive surface 11.

In one embodiment, the photosensitive surface 11 is a convex surface, that is, a central position of the photosensitive surface 11 extends outward. In the camera assembly 200, the central position of the photosensitive surface 11 protrudes toward the lens assembly 210.

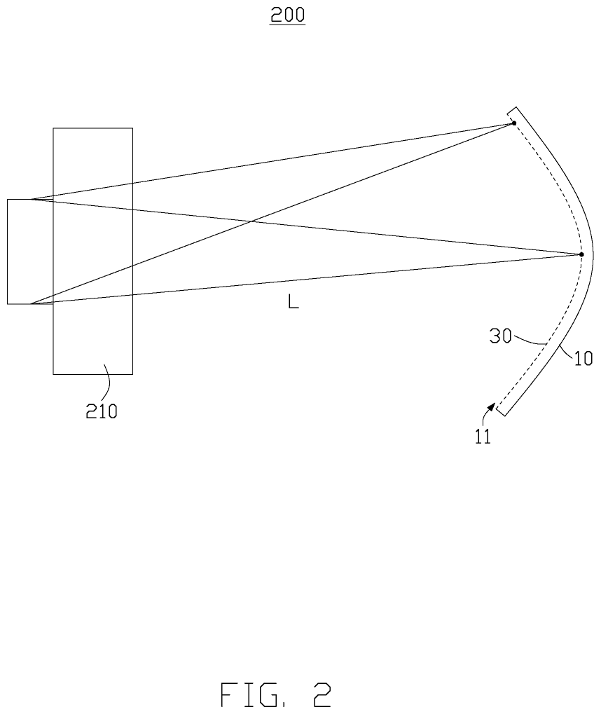

In another embodiment, as shown in FIG. 2, the photosensitive surface 11 is a concave surface. In the camera assembly 200, the central position of the photosensitive surface 11 is curved away from the lens assembly 210.

In other embodiments, the photosensitive surface 11 may be other shapes, which is not limited. As long as the shape of the photosensitive surface 11 matches optical parameters of the lens assembly 210, enabling the ambient light L propagating at different angles to converge onto the photosensitive surface 11, it shall fall within the scope of this disclosure.

The pixels 30 are arranged in an array including a plurality of rows and a plurality of columns, wherein each row extends along a first direction X and each column extends along a second direction Y perpendicular to the first direction X. A first spacing between the geometric centers of adjacent pixels 30 gradually decreases along the direction from the center to the edge of the substrate 10.

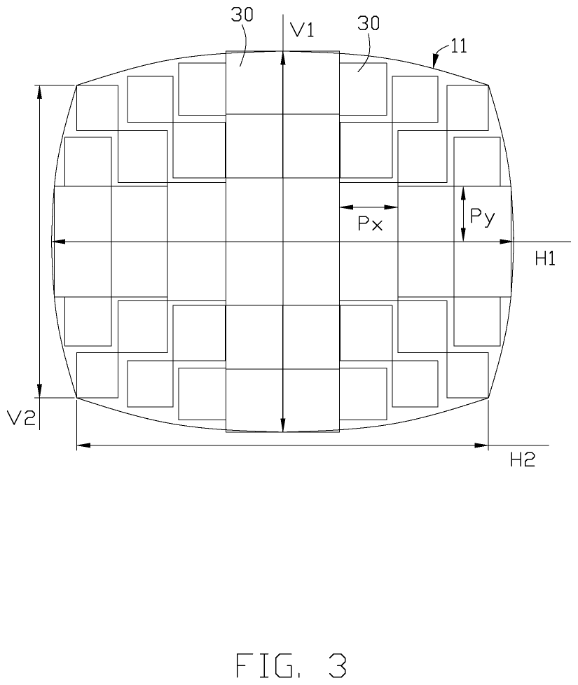

Referring to FIG. 3, in one embodiment, at least two pixels 30 have different sizes, and sizes of the pixels 30 gradually decrease from the center to the edge of the substrate 10.

Each pixel 30 has a size Px along the first direction X, which is determined by a maximum length H1 of the photosensitive surface 11 in the first direction X, a minimum length H2 of the photosensitive surface 11 in the first direction X, a number Hp of the pixel 30 in the first direction X (that is, a number Hp of the pixel 30 in each row), a position n of the pixel 30 in the first direction X, and a number Vp of the pixels 30 in the second direction Y (that is, a number Vp of the pixel 30 in each column).

Specifically,

$$P x = \frac{H 1}{H p} - \frac{2 ( n - 1 ) ( H 1 - H 2 )}{Hp ( Vp - 2 )} , ( n = 1 , 2 , 3 , … , \frac{Vp}{2} )$$

Each pixel 30 has a size Py along the first direction Y, which is determined by a maximum length V1 of the photosensitive surface 11 in the second direction Y, a minimum length V2 of the photosensitive surface 11 in the second direction Y, a number Vp of the pixels 30 in the second direction Y, a position n of the pixel 30 in the second direction Y, and the number Hp of pixels 30 in the first direction X.

Specifically,

$$P y = \frac{V 1}{Vp} - \frac{2 ( n - 1 ) ( V 1 - V 2 )}{Vp ( Hp - 2 )} , ( n = 1 , 2 , 3 , … , \frac{Hp}{2} ) .$$

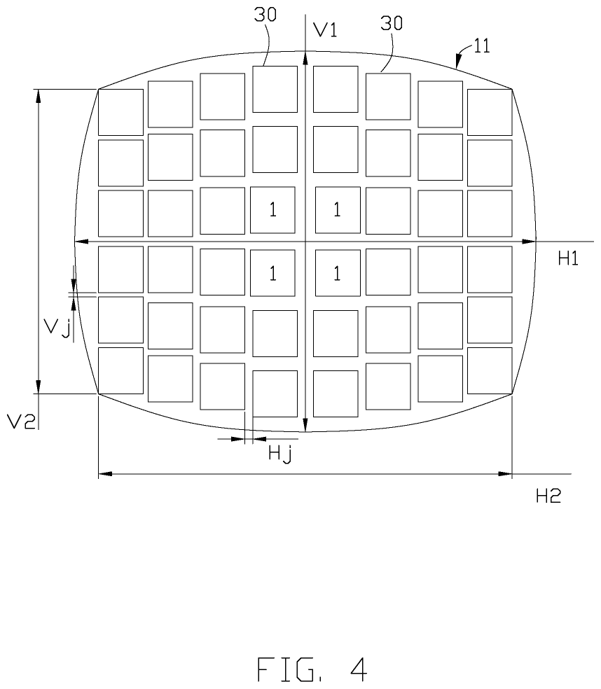

Referring to FIG. 4, in another embodiment, at least partial of the pixels 30 are spaced apart from each other, and a second spacing is between edges of each two adjacent pixels 30, wherein the second spacing gradually decreases from the center to the edge of the substrate 10.

A second spacing Hj is between each two adjacent pixels 30 arranged in the first direction X, which is determined by the maximum length H1 of the photosensitive surface 11 in the first direction X, the minimum length H2 of the photosensitive surface 11 in the first direction X, a number Hp of the pixels 30 in the first direction X, a position of the pixels 30 in the first direction X, and a number of the pixels 30 in the second direction Y.

Specifically,

$$Hj = \frac{H 1 - H 2}{Hp - 1} - \frac{2 ( n - 1 ) ( H 1 - H 2 )}{( Hp - 1 ) ( Vp - 2 )} , ( n = 1 , 2 , 3 , … , \frac{Vp}{2} )$$

A second spacing Vj is between each two adjacent pixels 30 arranged in the second direction Y, which is determined by a maximum length V1 of the photosensitive surface 11 in the second direction Y, a minimum length V2 of the photosensitive surface 11 in the second direction Y, a number Vp of the pixels 30 in the second direction Y, a position of the pixels 30 in the second direction Y, and a number of the pixels 30 in the first direction X.

Specifically,

$$Vj = \frac{V 1 - V 2}{Vp - 1} - \frac{2 ( n - 1 ) ( H1 - H 2 )}{( Vp - 1 ) ( Hp - 2 )} , ( n = 1 , 2 , 3 , … , \frac{Hp}{2} ) .$$

$$P x = H 2 / Hp , and Py = V2 / Vp .$$

The maximum size H1 of the photosensitive surface 11 in the first direction X equals a maximum beam size of the ambient light L received by the photosensitive surface 11 after distortion and projected onto the photosensitive surface 11. The minimum size H2 of the photosensitive surface 11 in the first direction X equals a minimum beam size of the light L received by the photosensitive surface 11 after distortion and projected onto the photosensitive surface 11. The maximum dimension V1 of the photosensitive surface 11 in the second direction Y equals a maximum beam size of the light L received by the photosensitive surface 11 after distortion and projected onto the photosensitive surface 11. The minimum size V2 of the photosensitive surface 11 in the second direction Y equals a minimum beam size of the light L received by the photosensitive surface 11 after distortion and projected onto the photosensitive surface 11.

The image sensor 100 provided in this embodiment of the present disclosure can achieve higher density at the edge of the photosensitive surface 11 by setting the sizes or spacings of the pixels 30, thereby equals resolutions of the ambient light L focused on the edge and the ambient light L focused on the center of the photosensitive surface 11, which can eliminate distortion of the lens assembly 210.

Referring to FIG. 1, in the camera assembly 200, the lens assembly 210 is on a side of the image sensor 100 having the photosensitive surface 11 and is used to focus the ambient light L onto the photosensitive surface 11.

The lens assembly 210 is a wide-angle lens assembly, that is, a field of view of the lens assembly 210 is greater than 60 degrees. The ambient light L emitted by the lens assembly 210 is projected onto the photosensitive surface 11, which is compatible with the lens assembly 210, so that the ambient light L from different angles can be focused on the photosensitive surface 11.

The camera assembly 200 provided in this embodiment of the present disclosure can receive the ambient light L emitted from the lens assembly 210 in different directions, thereby avoiding image blurring caused by the image sensor 100. By configuring arrangement of the pixels 30, the image sensor100 can compensate for the distortion of the lens assembly 210 from a hardware perspective, thereby improving image quality.

Finally, it should be noted that the above embodiments are only used to illustrate the technical solution of the present application and not to limit the present application. Although the present application has been described in detail with reference to preferred embodiments, one ordinary skill in the art should understand that the technical solution of the present application can be modified or equivalent replaced without departing from the spirit and scope of the technical solution of the present application.

What is claimed is:

1. An image sensor applied to a camera assembly comprising a lens assembly, the image sensor comprising:
a substrate comprising a curved photosensitive surface facing the lens assembly and arranged at a focus of ambient light transmitted from the lens assembly; and
a plurality of pixels on the curved photosensitive surface and arranged in an array comprising a plurality of rows and a plurality of columns, and each of the plurality of row extending along a first direction X and each of the plurality of columns extending along a second direction Y perpendicular to the first direction X;
wherein a first spacing between geometric centers of each two adjacent pixels of the plurality of pixels gradually decreases from a center of the substrate to an edge of the substrate.

2. The image sensor according to claim 1, wherein the curved photosensitive surface is a convex surface.

3. The image sensor according to claim 1, wherein the curved photosensitive surface is a concave surface.

4. The image sensor according to claim 1, wherein sizes of the plurality of pixels gradually decrease from the center to the edge of the substrate.

5. The image sensor according to claim 4, wherein a size of each of the plurality of pixels in the first direction X is determined by a maximum length and a minimum length of the photosensitive surface in the first direction X, a number of pixels, of the plurality of pixels, in the first direction X, a position n of each of the plurality of pixels in the first direction X, and a number of pixels, of the plurality of pixels, in the second direction Y.

6. The image sensor according to claim 5, wherein a size of each of the plurality of pixels in the second direction Y is determined by a maximum length and a minimum length of the photosensitive surface in the second direction Y, a number of pixels, of the plurality of pixels, in the second direction Y, a position n of each of the plurality of pixels in the second direction Y, and a number of pixels, of the plurality of pixels, in the first direction X.

7. The image sensor according to claim 1, wherein a second spacing between edges of each two adjacent pixels of the plurality of pixels gradually decreases from a center of the substrate to an edge of the substrate.

8. The image sensor according to claim 7, wherein the second spacing between each two adjacent pixels in the first direction X is determined by a maximum length and a minimum length of the photosensitive surface in the first direction X, a number of pixels, of the plurality of pixels, in the first direction X, a position n of each of the plurality of pixels in the first direction X, and a number of pixels, of the plurality of pixels, in the second direction Y.

9. The image sensor according to claim 8, wherein the second spacing between each two adjacent pixels in the second direction Y is determined by a maximum length and a minimum length of the photosensitive surface in the second direction Y, a number of pixels, of the plurality of pixels, in the second direction Y, a position n of each of the plurality of pixels in the second direction Y, and a number of pixels, of the plurality of pixels, in the first direction X.

10. A camera assembly comprising:
a lens assembly; and
an image sensor comprising:
a substrate comprising a curved photosensitive surface facing the lens assembly and arranged at a focus of ambient light transmitted from the lens assembly; and
a plurality of pixels on the curved photosensitive surface and arranged in an array comprising a plurality of rows and a plurality of columns, each of the plurality of row extending along a first direction X and each of the plurality of columns extending along a second direction Y perpendicular to the first direction X, and a first spacing between geometric centers of each two adjacent pixels of the plurality of pixels gradually decreasing from a center of the substrate to an edge of the substrate;
wherein the lens assembly is on a side of the image sensor having the photosensitive surface and is configured to focus the ambient light onto the photosensitive surface.

11. The camera assembly according to claim 10, wherein the curved photosensitive surface is a convex surface.

12. The camera assembly according to claim 10, wherein the curved photosensitive surface is a concave surface.

13. The camera assembly according to claim 10, wherein sizes of the plurality of pixels gradually decrease from the center to the edge of the substrate.

14. The camera assembly according to claim 13, wherein a size of each of the plurality of pixels in the first direction X is determined by a maximum length and a minimum length of the photosensitive surface in the first direction X, a number of pixels, of the plurality of pixels, in the first direction X, a position n of each of the plurality of pixels in the first direction X, and a number of pixels, of the plurality of pixels, in the second direction Y.

15. The camera assembly according to claim 14, wherein a size of each of the plurality of pixels in the second direction Y is determined by a maximum length and a minimum length of the photosensitive surface in the second direction Y, a number of pixels, of the plurality of pixels, in the second direction Y, a position n of each of the plurality of pixels in the second direction Y, and a number of pixels, of the plurality of pixels, in the first direction X.

16. The camera assembly according to claim 10, wherein a second spacing between edges of each two adjacent pixels of the plurality of pixels gradually decreases from a center of the substrate to an edge of the substrate.

17. The camera assembly according to claim 16, wherein the second spacing between each two adjacent pixels in the first direction X is determined by a maximum length and a minimum length of the photosensitive surface in the first direction X, a number of pixels, of the plurality of pixels, in the first direction X, a position n of each of the plurality of pixels in the first direction X, and a number of pixels, of the plurality of pixels, in the second direction Y.

18. The camera assembly according to claim 17, wherein the second spacing between each two adjacent pixels in the second direction Y is determined by a maximum length and a minimum length of the photosensitive surface in the second direction Y, a number of pixels, of the plurality of pixels, in the second direction Y, a position n of each of the plurality of pixels in the second direction Y, and a number of pixels, of the plurality of pixels, in the first direction X.
